(19) United States
(12) Patent Application Publication
(10) Pub. No.: US 2026/0117803 A1
(43) Pub. Date: Apr. 30, 2026

(54) STACKED HYDRAULIC TOOL ARRANGEMENT

(71) Applicant: Milwaukee Electric Tool Corporation, Brookfield, WI (US)

(72) Inventors: Justin T. Tillman, Brookfield, WI (US); Patrick C. Jalabert, Brookfield, WI (US); Benjamin J. Tretow, Mequon, WI (US); Mathew R. Rentmeester, Wauwatosa, WI (US); Spencer J. Tiegs, Pewaukee, WI (US)

(21) Appl. No.: 19/367,410

(22) Filed: Oct. 23, 2025

Related U.S. Application Data
(60) Provisional application No. 63/711,341, filed on Oct. 24, 2024.
(60) Provisional application No. 63/752,029, filed on Jan. 31, 2025.

(51) Int. Cl. F15B 15/20; F15B 13/02; F15B 15/14

(52) U.S. Cl. CPC F15B 15/20; F15B 13/024; F15B 15/1428; F15B 15/1447; F15B 15/149

(57) ABSTRACT

A hydraulic cylinder arrangement for a hydraulic tool that includes a cylinder and a piston assembly. The cylinder includes a first wall and a second wall. The piston assembly is moveably disposed within the cylinder. The piston assembly includes a piston rod, a first piston head, and a second piston head. The first piston head is coupled to the piston rod to define a first chamber between the first piston head and the first wall. The second piston head is coupled to the piston rod to define a second chamber between the second piston head and the second wall. The first chamber and the second chamber are fluidly coupled to one another.

### CROSS-REFERENCE TO RELATED APPLICATIONS

This application claims the benefit of and priority to U.S. Provisional Patent Application No. 63/752,029, filed Jan. 31, 2025, and U.S. Provisional Patent Application No. 63/711,341, filed Oct. 24, 2024, each of which is incorporated herein by reference in its entirety.

### BACKGROUND

The present disclosure relates to hydraulic tools. Hydraulic tools include a piston and typically a head including one or more jaws to provide an output force. The output force of a hydraulic tool is a function of pressure and area. Increasing the output force can be achieved by increasing the area. For example, some hydraulic tools can increase the output force by increasing the diameter of the tool.

### SUMMARY

A hydraulic tool, as described herein, may have various configurations. The hydraulic tool may have a hydraulic cylinder arrangement. The hydraulic cylinder arrangement can include a cylinder and a piston assembly.

According to one aspect, a hydraulic tool can include a hydraulic cylinder arrangement that may include a cylinder and a piston assembly. The cylinder can include a first wall and a second wall. The piston assembly can be moveably disposed within the cylinder. The piston assembly can include a piston rod, a first piston head, and a second piston head. The first piston head can be coupled to the piston rod to define a first chamber between the first piston head and the first wall. The second piston head can be coupled to the piston rod to define a second chamber between the second piston head and the second wall. The first chamber and the second chamber can be fluidly coupled to one another.

In some embodiments, the piston assembly can include the second piston head being secured to the piston rode with a first retainer. In some cases, the second piston head can be secured to the piston rod between a first seat and the first retainer.

In some embodiments, the piston assembly can include the first piston head to be monolithically formed with the piston rod.

In some embodiments, the piston assembly can include a piston rod that can include a first passage for fluid communication between the first chamber and the second chamber.

In some embodiments, the cylinder arrangement can include a second chamber that can be in fluid communication with a pump passage.

In some embodiments, the cylinder arrangement can include a third chamber that can be defined by the first piston head and a third wall of the hydraulic cylinder. In some cases, the cylinder arrangement can include a fourth chamber that can be defined by the first wall and the second piston head. In some cases, the piston rod can include a second passage for fluid communication between the third chamber and the fourth chamber. In some cases, the third chamber can be in fluid communication with a tank passage. In some cases, a first spring can be disposed in the third chamber. In some cases, a second spring can be disposed in the fourth chamber.

In some embodiments, the cylinder arrangement can include a first wall that can be secured to the cylinder between a second retainer and a second seat. In some cases, the second wall can be the end wall of the cylinder. In some cases, the end wall is an end cap that can be coupled to the cylinder.

In some aspects, a hydraulic actuator can include a first cylinder defining a first interior space and including a first open end and a first closed end. A second cylinder can define a second interior space and can include a second open end and a second closed end. The second closed end can be received in the first open end of the first cylinder. A piston assembly can be moveably disposed within the first interior space and the second interior space. The piston assembly can include a first piston having a first piston head positioned within the first interior space and a first piston rod extending through the second closed end into the second interior space. The first piston head can define a first chamber at the first closed end and a second chamber at the first open end within the first interior space. The piston assembly can include a second piston having a second piston head positioned within the second interior space and a second piston rod. The second piston head can be coupled to the first piston rod so that the second piston moves with the first piston. The second piston head can define a third chamber at the second closed end and a fourth chamber at the second open end within the second interior space. The third chamber can be fluidly coupled to the first chamber by a first passage defined in the first piston.

In some examples, the first piston can define a fifth chamber that receives a conduit tube that extends from the first closed end.

In some examples, hydraulic fluid can be supplied to the fifth chamber during a first stage of operation to move the piston assembly at a first speed. Hydraulic fluid can be supplied to the first chamber and the second chamber during a second stage of operation to move the piston assembly at a second speed that is slower than the first speed.

In some examples, the second piston can include a relief valve.

In some examples, the relief valve can be in a second passage defined in the second piston rod.

In some aspects, a hydraulic actuator can include a first cylinder defining a first interior space and including a first closed end and a first open end. A second cylinder can define a second interior space and can include a second closed end and a second open end that is coupled to the first closed end. A conduit tube can extend from the second closed end of the first cylinder. A first piston can have a first piston head positioned within the first interior space and a second piston rod. The first piston head can define a first chamber at the first closed end and a second chamber at the first open end within the first interior space. A second piston can have a second piston head positioned within the second interior space and a second piston rod extending through the first closed end into the first interior space. The second piston can define a second passage that receives the conduit tube to fluidly couple the first chamber to the conduit tube and to fluidly decouple the first chamber from the third chamber.

In some examples, hydraulic fluid can be supplied to the first chamber during a first stage of operation to move the piston assembly at a first speed. Hydraulic fluid can be supplied to the first chamber and the second chamber during a second stage of operation to move the piston assembly at a second speed that is slower than the first speed.

In some examples, the first piston can define a first passage that is selectively fluidly coupled to the second passage by a relief valve.

### BRIEF DESCRIPTION OF THE DRAWINGS

The accompanying drawings, which are incorporated in and form a part of this specification, illustrate embodiments of the disclosure and, together with the description, serve to explain principles of the embodiments:

FIG. 1 illustrates a hydraulic tool according to the present disclosure.

FIG. 2 illustrates a diagrammatic view of the hydraulic tool of FIG. 1.

FIG. 3 illustrates a schematic cross-sectional view of FIG. 1 taken along line III-III.

FIG. 4 illustrates another example of FIG. 3.

FIG. 5 illustrates another example of the hydraulic cylinder arrangement for the hydraulic tool of FIG. 1.

FIG. 6 illustrates yet another example of the hydraulic cylinder arrangement for the hydraulic tool of FIG. 1.

FIG. 7 illustrates a diagrammatic view of the hydraulic cylinder arrangement of FIG. 6.

FIG. 8 illustrates still another example of the hydraulic cylinder arrangement for the hydraulic tool of FIG. 1.

FIG. 9 illustrates yet another example of the hydraulic cylinder arrangement for the hydraulic tool of FIG. 1.

FIG. 10 illustrates still another example of the hydraulic cylinder arrangement for the hydraulic tool of FIG. 1.

FIG. 11 illustrates another example of the hydraulic cylinder arrangement for the hydraulic tool of FIG. 1.

FIG. 12 illustrates yet another example of the hydraulic cylinder arrangement for the hydraulic tool of FIG. 1.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

As briefly described above, hydraulic tools generally include a hydraulic actuator that generates an output force to perform a work function on a workpiece (e.g., a cut, a crimp, or a punch). Conventional hydraulic tools generally utilize hydraulic pressure to move a singular piston within a cylinder between a first position and a second position. In some examples, the hydraulic tool is a single-acting cylinder that creates force in a first direction. In other examples, the hydraulic tool is a double-acting cylinder that creates force in a first direction and a second direction. In some cases, the first direction corresponds with extension of the piston, and the second position corresponds with retraction of the piston, or vice versa.

An output force is created by pumping hydraulic fluid into a chamber to generate pressure along the interior surface area. The output force is a function of the pressure of the hydraulic fluid acting on a surface of the piston. Accordingly, output force is typically increased by either increasing the diameter of the cylinder or by increasing the pressure in the hydraulic fluid. However, modifying a hydraulic actuator to allow increased pressures or piston areas requires increasing the size of the power tool (e.g., larger cylinder diameters, larger pumps, thicker cylinder walls, etc.). Increasing the size of the power tool can make the power tool more cumbersome to use.

The present disclose provides improved arrangements of a hydraulic actuator that allow for increased force output without having to increase the overall size of the corresponding power tool. In particular, the present disclosure is related to improve piston and cylinder arrangements that allow for a larger effective area of the piston, upon which the hydraulic fluid acts to generate force.

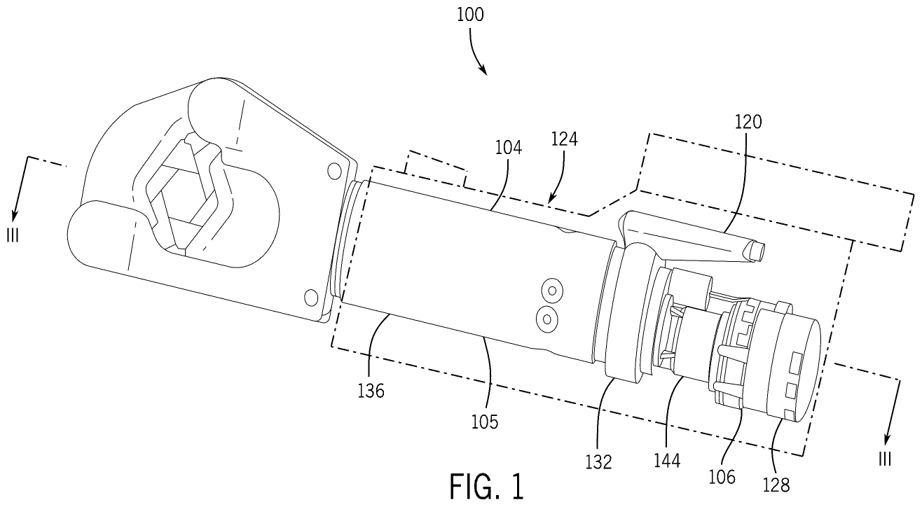

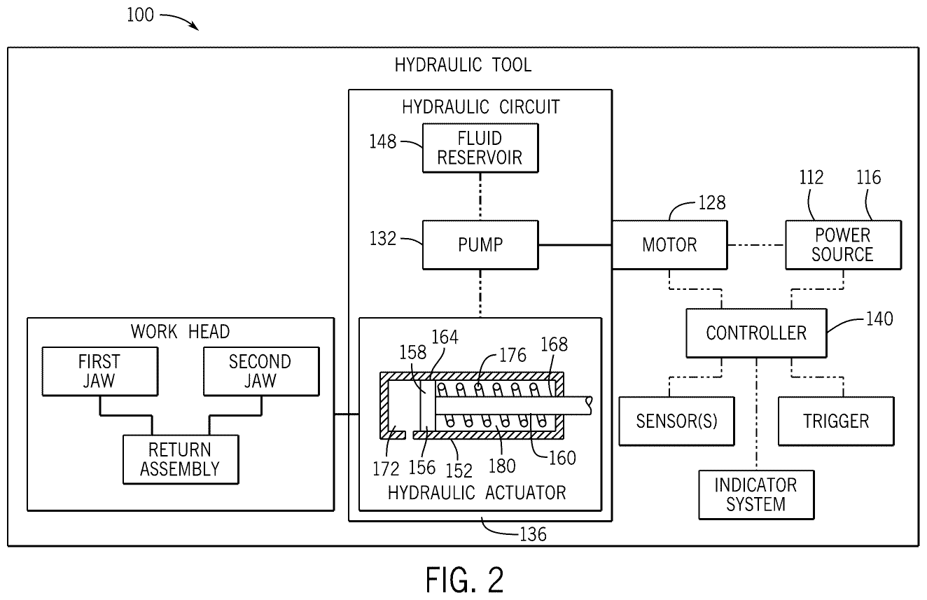

FIGS. 1 and 2 illustrate an example of a hydraulic tool 100, in accordance with the present disclosure. Although the example implementation described herein references a cutting tool, the features of this disclosure can be implemented in other similar tools, such as crimping tools or punching tools. In addition, any suitable size, shape or type of elements or materials could be used. The illustrated hydraulic tool 100 includes a housing 104 and a working head 108 that is coupled to the housing 104 to perform an operation on a work piece. The working head 108 is illustrated as a crimping head; however other types of working heads can also be used. The housing 104 defines a cylinder housing 105 that is attached to the working head 108 and a pump housing 106. The cylinder housing 105 includes a cylinder 152 and the pump housing 106 includes a pump 132. In some examples, the hydraulic tool 100 can be battery-operated and the housing 104 can define a battery receptacle 112 that is configured to receive a battery 116. In other examples the hydraulic tool 100 can be corded.

To operate the hydraulic tool 100, a trigger 120 is coupled to the housing 104. The trigger 120 can be manipulated by a user to actuate the hydraulic tool 100 and perform the work operation. For example, actuating the trigger 120 can control operation of an output assembly 124 that is disposed within the housing 104. The output assembly 124 includes a motor 128, the pump 132, and a hydraulic actuator 136 that acts on the working head 108 to perform the work operation. When the trigger 120 is pressed, electrical current can flow from the battery 116 to output assembly 124, causing the output assembly 124 to operate the working head 108 to perform the work operation. In some cases, the trigger 120 can communicate with an electronic controller 140 that controls a flow of electrical current from the battery 116 or another power source. More specifically, the electrical current can be provided to the motor 128 of the output assembly 124. The motor 128 can be coupled to the pump 132 so that rotation of the motor 128 operates the pump 132 to supply pressurized hydraulic fluid to the hydraulic actuator 136. In some cases, the motor 128 can be coupled to the pump 132 via a transmission 144 (e.g., a gear reducer).

Still referring to FIGS. 1-2, the hydraulic tool 100 includes the hydraulic actuator 136. The pump 132 supplies hydraulic fluid from a reservoir 148 (e.g., a tank) to the hydraulic cylinder 152. In general, the hydraulic cylinder 152 includes a piston 156 having piston head 158 and a piston rod 160. The piston 156 is moveably received in the cylinder 152 to form a first chamber 172 and a second chamber 180 within internal volume of the cylinder 152. A piston seal 164 is provided to seal between the piston head 158 and the cylinder 152 to prevent fluid from leaking between the first chamber 172 and the second chamber 180. A rod seal 168 is provided to seal between the cylinder 152 and the piston rod 160 to prevent hydraulic fluid from leaking out of the cylinder 152.

To operate the hydraulic actuator 136, the hydraulic cylinder 152 uses pressurized fluid to create mechanical motion. For example, hydraulic fluid is pumped into the first chamber 172. The pressure acting on the surface area of the piston 156 generates a force that causes to move the piston 156 to move within the cylinder 152 between a first position (e.g., a retracted position or an extended position) and a second position (e.g., the other of the retracted position and the extended position). In some cases, the hydraulic cylinder 152 is single acting. For example, hydraulic fluid is pumped to apply pressure to one side (e.g., first chamber 172) of the piston 156. Therefore, the piston 156 can only move in one direction by the generation of the force. A return mechanism 176 (e.g., spring or gravity) is used to return the piston 156 from the second position to the first position. In other cases, the hydraulic cylinder 152 is double-acting. For example, hydraulic fluid is pumped to apply pressure to both sides (e.g., the first chamber 172 and a second chamber 180) of the piston 156. Hydraulic fluid creates pressure along the surface in the first chamber 172, generating a force to move the piston 156 between the first position and the second position. To move the piston 156 between the second position and the first position, hydraulic fluid creates pressure along the surface in the second chamber 180 to generate a force.

Generally, if more force is required, the diameter of the hydraulic cylinder 152 is increased or pressure of the hydraulic fluid is increased. This typically requires increase the size of the tool, which may also result in increased weight that can make the tool more cumbersome to use for long periods of time, or make the tool more difficult to use in tight areas. The present disclosure provides an improved hydraulic cylinder arrangement to allow for a larger effective area of the piston 156 for the hydraulic fluid to act on to generate increased force without substantial increased to the size (e.g., external dimensions) of the hydraulic tool. In some examples, the hydraulic cylinder 152 can include the piston 156 having multiple piston heads (e.g., multiple piston heads). Each piston head has a corresponding pressure chamber that receives pressurized hydraulic fluid and increases the area on which the pressure can act, therefore increasing the output force of the tool. In some examples, the piston can be a piston assembly with piston heads monolithically formed with to the piston 156, or with separate the piston heads can be attached to a piston rod (e.g., with fasteners, adhesives, press-fit arrangements, etc.), or combinations thereof.

Referring to FIGS. 2-4, in some examples the hydraulic actuator 136 includes the hydraulic cylinder 152. The hydraulic cylinder 152 has a peripheral wall 184 that defines an interior space 188. Fluid can flow into and out of the interior space 188 for operating the hydraulic actuator 136. The interior space 188 can be subdivided into different sections by additional walls (e.g., interior or end walls) of the cylinder 152. In the illustrated example, the cylinder 152 includes a first wall 192 (e.g., an intermediate or interior wall) positioned within the interior space 188. The first wall 192 is between a second wall 196 (e.g., a first end wall) and a third wall 200 (e.g., a second end wall). Correspondingly, the interior space 188 includes a first interior space 201 between the first wall 192 and the second wall 196, and a second interior space 202 between the first wall 192 and the third wall 200. As described in greater detail below, the first wall 192 acts as a partition between the piston heads in the piston 156.

In some cases, the first wall 192 is secured to the cylinder 152 between a first retainer 204 and a first seat 208. Examples of the first retainer 204 include snap rings, circlips, piston pins, etc. The first seat 208 is defined by a ledge formed in the peripheral wall 184 of the hydraulic cylinder 152. The first wall 192 includes a seal 194 (e.g., O-ring, hydraulic seal, or a guide ring, etc.) to seal between the first wall 192 and the peripheral wall 184. In some cases, the second wall 196 is an end wall of the cylinder. In some cases, the end wall is an end cap (e.g., cylinder head, end plug, compression end cap) that is coupled to the hydraulic cylinder 152. In other cases, the third wall 200 is also an end wall (e.g., cylinder head). The first wall 192 and the second wall 196 include an orifice for the piston rod 160 as described further below.

There is a piston assembly moveably disposed within the hydraulic cylinder 152. The piston assembly includes the piston rod 160, a first piston head 212, and a second piston head 216.

The first piston head 212 is positioned within the first interior space 201. The first piston head 212 subdivides the first interior space 201 to define a first chamber 228 between the first piston head 212 and the second wall 196 and a second chamber 229 between the first piston head 212 and the first wall 192. For example, the first chamber 228 can increase in size as the first piston head 212 moves in the first direction with the piston rod 160 (e.g., toward the third wall 200) and can decrease in size as the first piston head 212 moves with the piston rod 160 in the second direction (e.g., toward the second wall 196), or vice versa. Correspondingly, the second chamber 229 can decrease in size as the first piston head 212 moves in the first direction and can increase in size as the first piston head 212 moves in the second direction, or vice versa. The first piston head 212 can be attached to the piston rod 160. In the illustrated example the is secured to the piston rod 160 by a second retainer 236. The second retainer 236 secures the first piston head 212 against a second seat 240. For example, the second retainer 236 can include snap rings, circlips, piston pins, etc. The second seat 240 is a ledge formed in the piston rod 160. In other examples the first piston head 212 and the piston rod 160 can be coupled in other ways, including being formed with the piston rod 160.

The second piston head 216 is positioned within the second interior space 202. The second piston head 216 subdivides the second interior space 202 to define a third chamber 232 between the second piston head 216 and the first wall 192 and a fourth chamber 260 between the second piston head 216 and the third wall 200. For example, the third chamber 232 can increase in size as the second piston head 216 moves in the first direction with the piston rod 160 and can decrease in size as the second piston head 216 moves in the second direction with the piston rod 160, or vice versa. Correspondingly, the fourth chamber 260 can decrease in size as the first piston head 212 moves in the first direction and can increase in size as the first piston head 212 moves in the second direction, or vice versa. The second piston head 216 is shown being monolithically formed with the piston rod 160. In other examples, the second piston head 216 can be attached to the piston rod 160 by a fastener, press-fit connection, threaded connection, etc.

Seals can be used to prevent leakage between chambers of a hydraulic actuator. Here, the first piston head 212 includes a seal 224 (e.g., a first seal) to seal against the cylinder 152 wall to prevent leakage between the first chamber 228 and the second chamber 229. Similarly, the second piston head 216 includes a seal 220 (e.g., a second seal) to seal against the cylinder 152 wall to prevent leakage between the third chamber 232 and the fourth chamber 260. The seals 220 and 224 may be O-rings, hydraulic seals, or guide rings. The piston rod 160 extends through the first piston head 212 and the first wall 192.

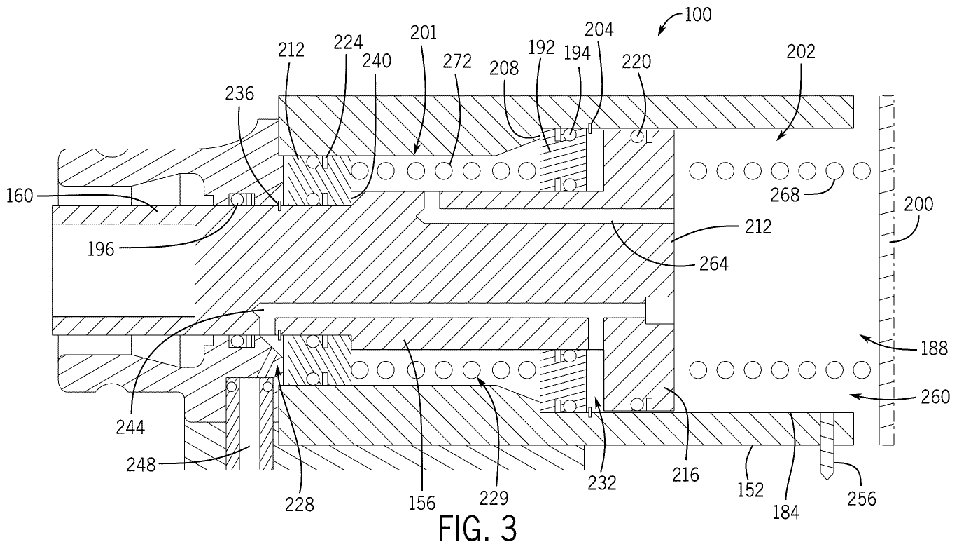

The first chamber 228 and the third chamber 232 are fluidly coupled to one another. FIGS. 3-4 show an illustrated example in the piston assembly. A first passage 244 is defined between the first chamber 228 and the third chamber 232. The first passage 244 is located within the piston rod 160. The first passage 244 port in the first chamber 228 can be located next to the second retainer 236, as may ensure the passage 244 port remains in the first chamber 228. The first passage 244 port in the third chamber 232 can be located next to the second piston head 216, as may ensure the passage 244 port remains in the third chamber 232. The first passage 244 can be a high-pressure communication line. The first chamber 228 is in fluid communication with a pump passage 248. The pump passage 248 can pump hydraulic fluid into the first chamber 228. For example, as hydraulic fluid is pumped into the first chamber 228, pressure begins to increase in the first chamber 228. The pressure of the hydraulic fluid acts on the surface area of the first chamber 228 generating a force. The force moves the piston assembly (i.e., the piston rod 160, the first piston head 212, and the second piston head 216) in the first direction. In other examples, the first passage 244 connecting the first chamber 228 to the third chamber 232 can positioned differently, for example, in the cylinder 152 or as external hose connection.

The hydraulic cylinder arrangement includes the second chamber 229. The second chamber 229 is defined within the first interior space 201. The second chamber 229 is between the first wall 192 and the first piston head 212. In some examples, the second chamber 229 is a first flooded chamber that retains hydraulic fluid. For example, as the piston assembly moves in a first direction (e.g., towards the third wall 200), the second chamber 229 decreases in volume. As the second chamber 229 decreases in volume, fluid pressure needs to be relieved to allow continued movement of the piston.

The hydraulic cylinder arrangement includes the fourth chamber 260. The fourth chamber 260 is defined within the second interior space 202. The fourth chamber 260 is between the second piston head 216 and the third wall 200. In some examples, the fourth chamber 260 is a second flooded chamber that retains hydraulic fluid. The fourth chamber 260 is in fluid communication with a tank passage 256. As the piston assembly moves in the first direction (e.g., towards the third wall 200), the fourth chamber 260 decreases in volume. As fourth chamber 260 is decreasing in volume, pressure is relieved by hydraulic fluid flowing through the tank passage 256.

Referring again to the illustrated examples in FIG. 3 and FIG. 4, the second chamber 229 and the fourth chamber 260 are fluidly coupled to one another. A second passage 264 is defined between the second chamber 229 and the fourth chamber 260. The second passage 264 is located within the piston rod 160. The second passage 264 port in the second chamber 229 is located on the piston rod 160 between the first piston head 212 and the first wall 192. The second passage 264 port for the fourth chamber 260 is located on the second piston head 216. The second passage 264 can be a low-pressure communication line. For example, as the second chamber 229 builds up pressure when the piston assembly moves in the first direction (e.g., towards the third wall 200), hydraulic fluid enters the second passage 264 and flows to the fourth chamber 260. Further, as the pressure increases in the fourth chamber 260 the hydraulic fluid enters the tank passage 256. The hydraulic fluid flows to the pump passage 248 and is repumped into the first chamber 228. This process may continue until the piston assembly has completed motion in the first direction. In some cases, motion in the first direction corresponds to retraction of the piston assembly, and a second direction corresponds to extension of the piston assembly, or vice versa. In other examples, the second passage 264 connecting the second chamber 229 to the fourth chamber 260 can positioned differently, for example, in the cylinder 152 or as external hose connection.

In some examples, a first spring 268 is optionally disposed within the fourth chamber 260. In some examples, a second spring 272 is optionally disposed within the second chamber 229. For example, as the piston assembly moves in the first direction, the first spring 268 and the second spring 272 are compressed. As the first spring 268 and the second spring 272 are compressed, they store potential energy. The potential energy is converted into kinetic energy to move the piston assembly in the second direction. As the first spring 268 and second spring 272 move the piston assembly in the second direction, the third chamber 232 decreases in size and builds up pressure. The pressure in the third chamber 232 is relieved through the first passage 244. The hydraulic fluid flows through the first passage 244 to the first chamber 228. The hydraulic fluid flows back through the pump passage 248 to the tank passage 256 and enters the fourth chamber 260. Additionally, hydraulic fluid flows from the fourth chamber 260 to the second chamber 229 through the second passage 264 to replenish the hydraulic fluid that was evacuated during the movement in first direction. This process is continued until the first spring 268 and second spring 272 are fully extended and the piston assembly has returned to the starting position.

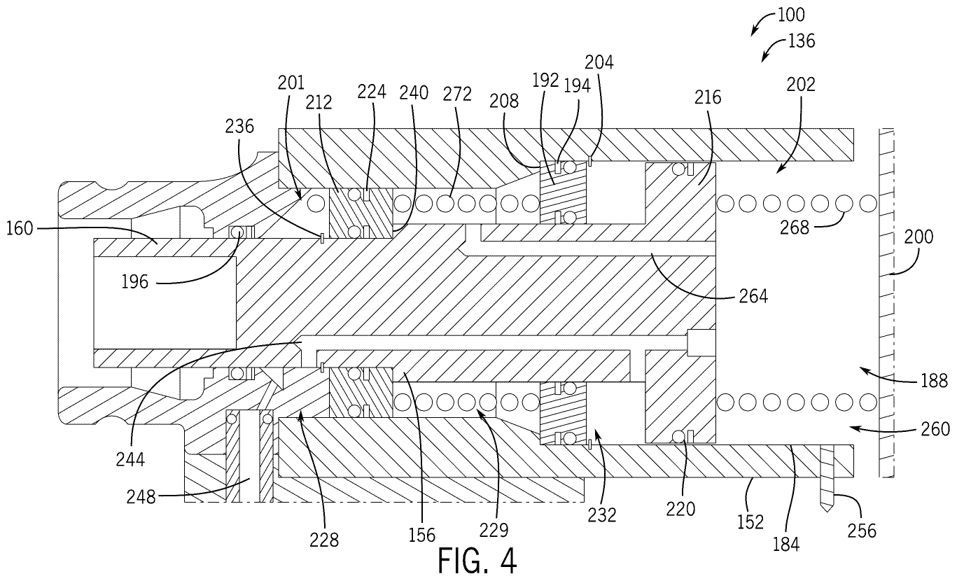

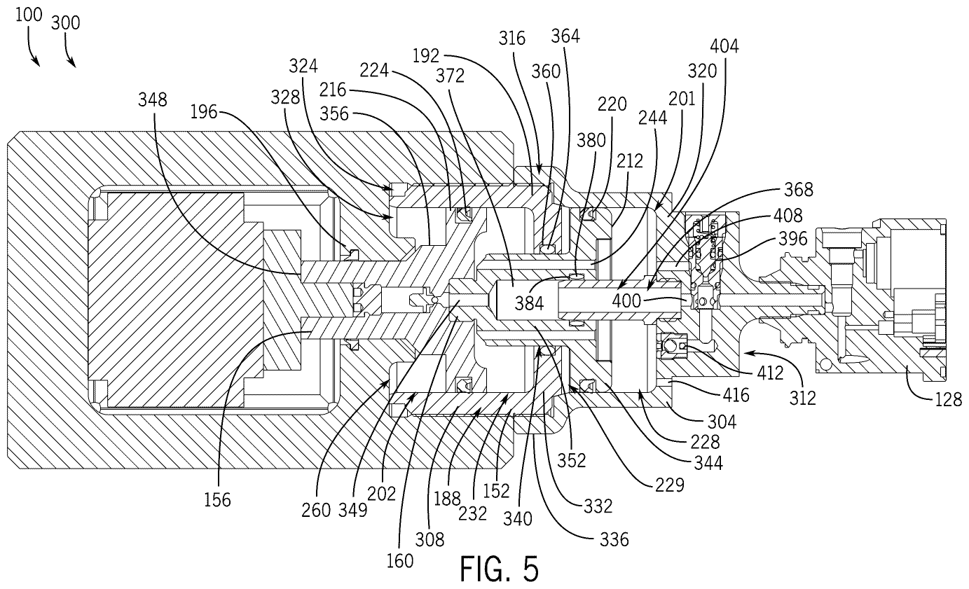

FIG. 5 illustrates an example hydraulic actuator 300, which is another example of the hydraulic actuator 136 for use with the hydraulic tool 100 of FIG. 1. To that end, features of the hydraulic actuator 300 described below include reference numbers that are similar to those used in FIGS. 1-4, and discussion above applies to similar named and numbered items below, unless otherwise noted or required. For example, the hydraulic actuator 300 includes a piston 156 that is received in a hydraulic cylinder 152. The piston 156 includes a first piston head 212 and a second piston head 216.

In some examples, a hydraulic cylinder can be formed from multiple cylinder portions for easier assembly. For example, the hydraulic actuator 300 includes the cylinder 152 formed from a first cylinder 304 and a second cylinder 308 that are coupled together. The first cylinder 304 defines a first end 312 of the hydraulic actuator 300. More specifically, the first cylinder 304 includes an open end 316 and a closed end 320 (e.g., end wall). Correspondingly, the first cylinder 304 defines the first interior space 201 to receive the first piston head 212. The second cylinder defines a second end 324 of the hydraulic cylinder 152. More specifically, the second cylinder 308 includes an open end 328 and a closed end 332 and defines the second interior space 202 to receive the second piston head 216. The open end 328 contacts the second wall 196 of the hydraulic cylinder 152 and the closed end 332 corresponds with the first wall 192. The open end 316 of the first cylinder 304 includes a flange 336 to couple (e.g., by treads, press-fit, snap rings, etc.) to the closed end 332 of the second cylinder 308. The closed end 332 of the second cylinder 308 defines an opening 340 through which the piston rod 160 is received.

The piston 156 is movably received in the interior space 188 of the hydraulic cylinder 152. The piston 156 includes the piston rod 160, the first piston head 212, and the second piston head 216. The first piston head 212 is positioned in the first interior space 201 to form the first chamber 228 and the second chamber 229. The second piston head 216 is positioned in the second interior space 202 to form the third chamber 232 and the fourth chamber 260. The first chamber 228 and the third chamber 232 are fluidly coupled with one another. More specifically, the first chamber 228 and the third chamber 232 are coupled by a first passage 244. In the illustrated example, the first passage 244 is defined in the piston rod 160. The first passage 244 can be also positioned elsewhere (e.g. external to the cylinder 152 or in the cylinder wall).

In some examples, a piston can be formed as a multi-piece piston to facilitate assembly. A piston can be formed from a first piston and a second piston that are coupled together and that each include a respective piston head and a piston rod. For example, the piston 156 of the hydraulic actuator 300 is formed from a first piston 344 and a second piston 348 that are coupled together. In the illustrated example, the first piston 344 and the second piston 348 are coupled by a fastener 349. In some cases, the first piston 344 can define a channel 372 and the fastener 349 can be positioned in the channel to couple to the second piston 348. In other examples, other methods of fastening can be used, for example, threading of the first piston 344 to the second piston 348, a pinned connection, press-fit, etc.

The first piston 344 includes the first piston head 212 that is formed as a single piece with a first piston rod 352. The second piston 348 includes the second piston head 216 that is formed as a single piece with a second piston rod 356. The first piston rod 352 is fixedly coupled to the second piston head 216 or the second piston rod 356 so the first piston 344 and the second piston 348 move together. The first piston rod 352 extends though the opening 340 in the first wall 192 (e.g., the closed end 332 of the second cylinder 308). Correspondingly, the first wall 192 includes an annular groove 360 to receive a piston seal 364 to seal against the first piston rod 352. The second piston rod 356 extends out of the cylinder 152 (e.g., through the second wall 196) to engage with and operate a working head of the hydraulic tool 100.

In some examples, a hydraulic cylinder or piston can be configured to allow for two-stage movement to modulate the speed or force output. In some cases, a first stage of extension can be high-speed and low-force while a second stage of extension can be low-speed and high force, or vice versa. For example, a first stage of movement (e.g., extending to a workpiece or retracting from a workpiece) correlates to high speed with low force extension or retraction of the piston, while a second stage of movement (e.g., performing an action on the workpiece) correlates to low speed with high force extension or retraction of the piston. In some examples, the piston can switch between the first stage and second stage when the piston reaches the workpiece.

To allow for different stages of extension, a hydraulic cylinder can include a conduit tube that is fixed to an end wall of the hydraulic cylinder. The conduit tube can direct fluid from a pump (e.g., pump 132) to a channel to define a single chamber or subset of chambers of a hydraulic actuator to enable higher speed extension for a given flow rate of fluid. For the second stage, fluid can be supplied from the pump to some or all of the remaining chambers. To allow switching between stages, the hydraulic actuator can include a valve system (e.g., one or more of a sequence valve, check valve, shear seal valve, etc.).

Still referring to FIG. 5, a conduit tube 368 is fixedly coupled to the first wall 192 of the first cylinder 304. The conduit tube 368 is received in the channel 372 that is defined in the piston rod 160 (e.g., in the first piston rod 352). The channel 372 is configured as a closed channel so that the channel 372 forms a chamber (e.g., a pre-chamber or fifth chamber). Fluid can be supplied to the channel 372 via the conduit tube 368 to cause movement of the piston 156. A seal 384 can be provided between the piston rod 160 and the conduit tube 368 to prevent leakage out of the channel 372 and into the second chamber 229. In the illustrated example, the channel 372 defines an annular groove 380 that receives the seal 384 to seal against the conduit tube 368. In other examples, the seal can be positioned differently (e.g., to be coupled to the conduit tube).

A hydraulic cylinder can include a sequence valve to control fluid flow from the pump to various chambers to control extension. In the illustrated example, the hydraulic actuator 300 includes a sequence valve 396. The sequence valve 396 is moveable between a first position (e.g., closed) and a second position (e.g., open). In the first position, the sequence valve 396 allows fluid to be supplied from the pump 132 through a first inlet 400 to the channel 372, while a second inlet 408 is blocked. In the second position, the sequence valve 396 allows fluid through the first inlet 400 to the channel 372, as well as through second inlet 408 to the first chamber 228. Fluid supplied to the first chamber 228 is also supplied to the third chamber 232 via the first passage 244.

With a sequence valve in a first position, a first stage of fluid flow is provided to a chamber having less than a total acting surface area of a piston so that a piston extends at a higher rate because fluid is supplied to a volume with a smaller cross-sectional area. Therefore, for a given flow rate the piston extends at a higher rate to account for the change in volume. The piston rod 160 defines the channel 372 and the conduit tube 368 is in the channel 372 to define a passage 404 between the first inlet 400 and the channel 372. On a first stage of extension, the sequence valve 396 is in the first position so that the first inlet 400 is open and the second inlet 408 is closed (e.g., by selective blocking of the sequence valve 396). The pump 132 provides fluid through the first inlet 400 into the channel 372 (via the conduit tube 368). As a result, the first piston 344 and the second piston 348 move together in the first direction (e.g., extension toward a workpiece), which increases the volume of the first chamber 228 and the third chamber 232. To prevent a vacuum and equalize pressure in the first chamber 228 and the third chamber 232 that would oppose movement, a check valve 412 can be provided to allow hydraulic fluid to be drawn in from the reservoir 148 by movement of the piston 156. As shown in FIG. 5, in some cases, the check valve 412 is located in the first chamber 228, and opens when the pressure in the first chamber 228 is below a pressure of in the reservoir 148 to allow fluid to flow freely into the first chamber 228 from the reservoir 148. That is, the check valve 412 allows fluid to flow from the reservoir 148 into the first chamber 228 and through the first passage 244 to third chamber 232. In some cases, the piston 156 can continue to move rapidly via the first stage of extension until pressure in the chambers 228 and 232 increases above a threshold level, as may occur upon contacting a workpiece. A dump valve 416 can be provided to allow fluid to flow out when the piston 156 moves in a second direction (e.g., retraction of the piston).

In some cases, it may be beneficial to switch from a first stage of extension to a second stage of extension when a piston reaches a workpiece. To do so, the sequence valve 396 moves from the first position to the second position when the sequence valve 396 detects the workpiece (e.g., via a pressure change, manual activation, or other control signal), thereby switching the first stage of extension to a second stage of extension. In the second stage, the first inlet 400 remains open and the second inlet 408 is also opened to allow fluid into the first chamber 228. Fluid is pumped through the second inlet 408 to the first chamber 228 through the first passage 244 to the third chamber 232, in addition to the first inlet 400 to the channel 372 via the conduit tube 368. The piston 156 extends at a slower rate because the fluid fills a volume with a larger cross-sectional area defined by the first piston head 212 and the second piston head 216 (i.e., in the first chamber 228 and the third chamber 232). While the rate of movement is decreased (e.g., extension or retraction depending on the particular configuration), the force applied by the piston 156 is increased because the fluid is acting on a larger cross-sectional area (e.g., the channel 372, the first piston head 212 and the second piston head 216), as compared with the first stage. The second stage of extension may correspond with performing an action (e.g., a crimp, cut, punch) on a workpiece that requires a larger force.

In some cases, a piston assembly can include relief valve. For example, still referring to FIG. 5, a relief valve is positioned in a passage defined in the second piston 348 (e.g., in the second piston rod 356. The relief valve selectively couples the passage with the channel 372. So, when pressure in fifth chamber reaches a crack pressure of the relief valve, the relief valve can open to allow hydraulic fluid to bleed through the second piston 356.

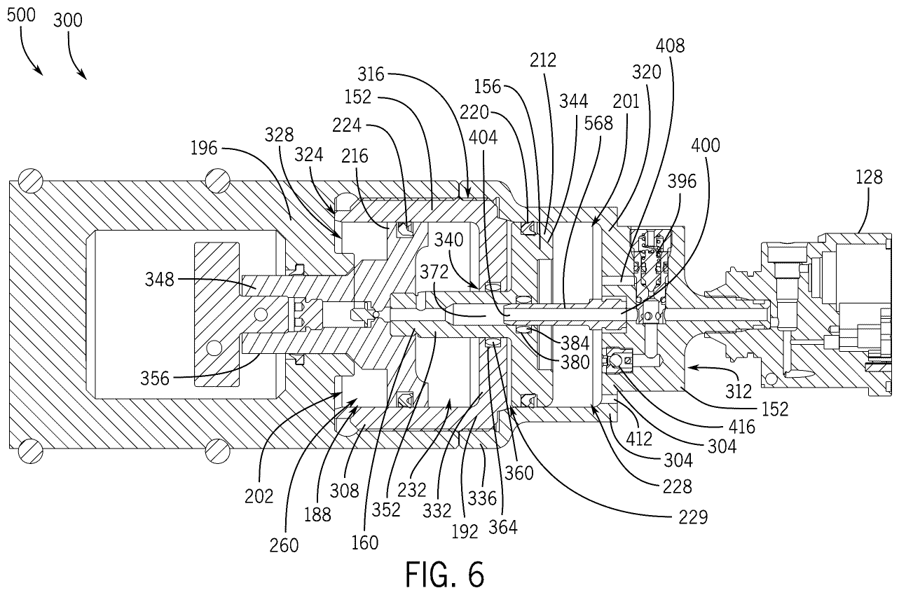

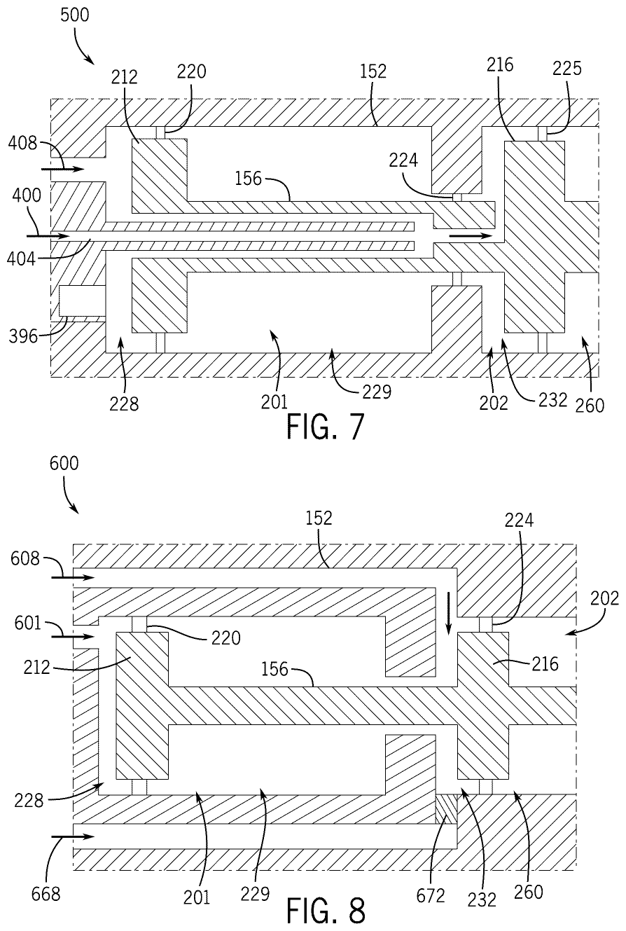

In some cases, a hydraulic actuator can have fluid passages that are configured differently to allow for a more compact actuator. FIGS. 6 and 7 illustrate an example hydraulic actuator 500, which is another example of a hydraulic actuator 136 according to aspects of the disclosure for use with the hydraulic tool 100 of FIG. 1. To that end, features of the hydraulic actuator 500 described below include reference numbers that are generally similar to those used in FIGS. 1-5, and discussion applies to similar named and numbered items below, unless otherwise noted or required.

In some cases, fluid passages within a hydraulic cylinder can be arranged differently to achieve multi-stage extension. For example, a first chamber defined in a cylinder by a piston can be filled for a first stage of extension, while a first chamber and a second chamber defined in the cylinder by the piston can be filled for a second stage of extension. Put more generally, a set of chambers can correspond with a stage of movement when filled, while a subset of the set of chambers can correspond with another stage of movement when filled. In the illustrated example, the hydraulic actuator 500 includes cylinder 152 that is formed from a first cylinder 304 and a second cylinder 308, and a piston 156. The first piston rod 352 defines a channel 372 to receives the conduit tube 568. The channel 372 is configured as an open channel to allow fluid to flow from the pump 132 and into the third chamber 232.

For the first stage extension in the hydraulic actuator 500, fluid is pumped through the first inlet 400 into the channel 372 via the conduit tube 568 to the third chamber 232. The piston 156 extends rapidly because full pump flow is supplied to the third chamber 232. To equalize pressure in the first chamber 228, fluid can be drawn into the first chamber 228 from the reservoir 148 via opening of the sequence valve 396.

For a second stage of extension, fluid is pumped through a second inlet to a first chamber, in addition to a second chamber, thereby dividing flow between the two chambers. For example, for the second stage of extension in the hydraulic actuator 500, the sequence valve 396 is in the second position allowing fluid to be pumped through both the first inlet 400 and the second inlet 408. The piston 156 extends at a slower rate because the fluid fills both chambers, which has the effect of filling a volume with a larger cross-sectional area defined by both the first piston head 212 and the second piston head 216 (i.e., in the first chamber 228 and the third chamber 232). While the rate of movement is decreased, the force applied by the piston 156 is increased because the fluid is acting on a larger cross-sectional area (e.g., the pre-chamber, the first piston head 212 and the second piston head 216), as compared with the first stage.

In some cases, a piston assembly can include relief valve. For example, still referring to FIG. 6, a relief valve is positioned in a passage defined in the second piston 348 (e.g., in the second piston rod 356. The relief valve selectively couples the passage with the channel 372. So, when pressure in the third chamber 232 or the channel 372 reaches a crack pressure of the relief valve, the relief valve can open to allow hydraulic fluid to bleed through the second piston 356.

In some cases, a hydraulic cylinder can have external flow to simplify piston geometries. FIG. 8 illustrates an example hydraulic actuator 600, which is another example of the hydraulic actuator 136 according to aspects of the disclosure for use with the hydraulic tool 100 of FIG. 1. To that end, features of the hydraulic actuator 600 described below include reference numbers that are generally similar to those used in FIGS. 1-7, and discussion applies to similar named and numbered items below, unless otherwise noted or required.

A first inlet and a second inlet can be configured in a different arrangement to provide fluid to chambers to achieve multi-stage extension. In some cases, a first chamber defined in a cylinder by a piston can be filled for a first stage of extension via a first inlet, while a first chamber and a third chamber defined in the cylinder by the piston can be filled for a second stage of extension via a first inlet and a second inlet, respectively. For example, the hydraulic actuator 600 includes a cylinder 152 that defines a first inlet 601 and a second inlet 608. As shown in FIG. 8, the second inlet 608 is external to the hydraulic actuator 600. The hydraulic actuator 600 also includes a first passage 668 (e.g., a pre-fill passage) that is external to the piston 156. The first passage 668 includes a check valve 672 to allow filing from the reservoir 148.

For a first stage of extension, fluid is pumped through a first inlet into a first chamber. For example, for the first stage of extension in the hydraulic actuator 600, fluid is pumped through the first inlet 601 into the first chamber 228 to move the piston 156 in the first direction. The check valve 672 allows hydraulic fluid to be drawn in from the reservoir 148 and through the first passage 668 in response to movement of the piston 156. As shown in FIG. 8, in some cases, the check valve 672 opens when the pressure in the third chamber 232 is below a pressure in the reservoir 148 to allow fluid to freely flow into the third chamber 232.

For a second stage of extension, fluid is pumped through a second inlet to a second chamber in addition to a first inlet to a first chamber. For example, for the second stage of extension in the hydraulic actuator 600, fluid is pumped through the second inlet 608 to the third chamber 232 in addition to the first inlet 601 to the first chamber 228.

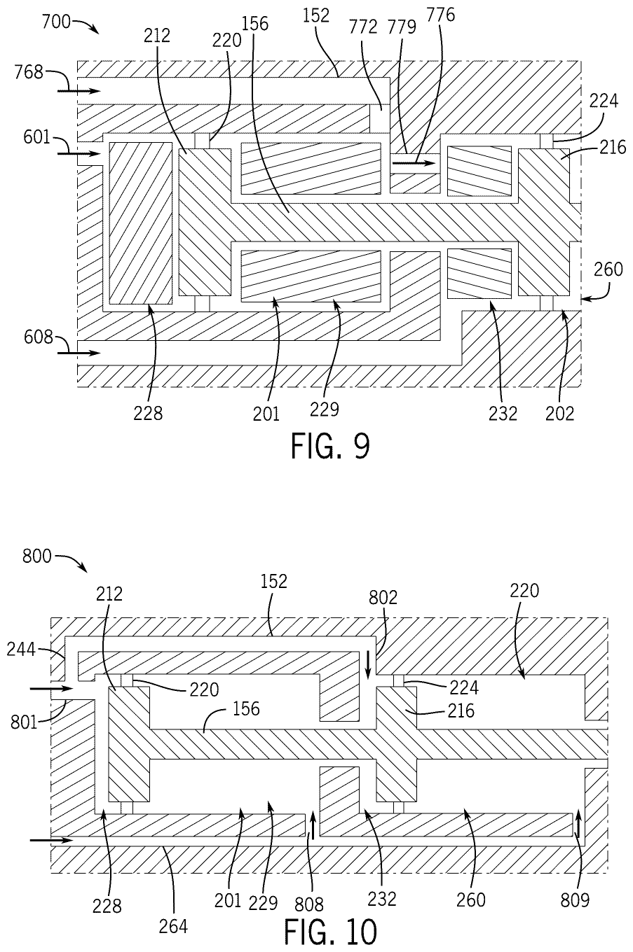

In some cases, a hydraulic cylinder can include hydraulic fluid backfill to simplify the piston geometry. FIG. 9 illustrates an example hydraulic actuator 700, which is another example of a hydraulic actuator 136 according to aspects of the disclosure for use with the hydraulic tool 100 of FIG. 1. To that end, features of the hydraulic actuator 700 described below include reference numbers that are generally similar to those used in FIGS. 1-8, and discussion applies to similar named and numbered items below, unless otherwise noted or required.

In the illustrated example, the hydraulic actuator includes a first inlet 601 to supply fluid to the first chamber 228, a second inlet 608 to supply fluid to the third chamber 232, and a third inlet 768 to supply fluid to the second chamber 229. As described further below, fluid can be selectively pumped (e.g., via operation of a valve system) into the first chamber 228 and the third chamber 232 via the first inlet 601 and the second inlet 608, respectively. A check valve 772 (e.g., a refill valve) can positioned to allow fluid into the second chamber 229 from the reservoir 148. A passage 776 is provided to supply fluid from the second chamber 229 to the third chamber 232. In this case, the passage 776 is provided in the cylinder 152, however, it can be positioned differently in other examples, (e.g., in the piston 156). In some cases, a check valve (e.g., a prefill valve 779 can be positioned along the passage 776 to block flow to the third chamber 232 from the second chamber 229, as may prevent pump flow from entering the third chamber 232, which could inhibit movement of the piston 156.

In some cases, a hydraulic actuator can include chambers pre-filled (e.g., flooded) with hydraulic fluid. For example, the second chamber 229 is a flooded chamber that is pre-filled with hydraulic fluid. For a first stage of extension, fluid is pumped into a first chamber. Fluid is pumped into the hydraulic actuator 700 through the first inlet 601 into the first chamber 228. As the piston 156 moves in the first direction, the prefill check valve 779 opens when the pressure in the third chamber 232 is below a pressure in the second chamber 229 to allow fluid to freely flow into the third chamber 232.

For a second stage of extension of the hydraulic cylinder 700, fluid is pumped through the first inlet 601 into the first chamber 228 and the second inlet 608 into the third chamber 232 to move the piston in the first direction. Similar to the first stage of extension, as the piston 156 moves in the first direction, and hydraulic fluid in the second chamber 229 flows through the prefill check valve 779 into the third chamber 232. Accordingly, fluid is supplied to the first chamber 228 from the pump 132 and fluid is supplied to the third chamber 232 from both the pump 132 and the second chamber 229.

When the piston 156 moves in the opposite direction, fluid from the first chamber 228 and the third chamber 232 is drained back to the reservoir. Because the volume of the second chamber 229 is increased while the volume of the third chamber 232 is decreased, the prefill check valve 779 can close due to the relative pressure differential between the second chamber 229 and the third chamber 232 to prevent fluid flow from the third chamber 232 to the second chamber 229. Correspondingly, the check valve 772 opens when the pressure in the second chamber 229 is below a pressure in the reservoir 148 to allow fluid to freely flow into the second chamber 229 to replace the hydraulic fluid that flowed into the third chamber 232 during the first and second stages of extension.

In some cases, a hydraulic actuator can be configured as a double acting actuator. This can create a high force output with fast return, as compared with a single acting cylinder. FIG. 10 illustrates an example hydraulic actuator 800, which is another example of a hydraulic actuator 136 according to aspects of the disclosure for use with the hydraulic tool 100 of FIG. 1. To that end, features of the hydraulic actuator 800 described below include reference numbers that are generally similar to those used in FIGS. 1-8, and discussion applies to similar named and numbered items below, unless otherwise noted or required. To provide double-acting operation for a hydraulic actuator, a first set of inlets supplies hydraulic fluid to a first chamber and a third chamber, and a second set of inlets supplies hydraulic fluid to a second chamber and a fourth chamber. A set of inlets, as used herein, can include one or more inlets. In the illustrated example, the hydraulic actuator 800 includes a first set of inlets to supply fluid to a first set of chambers. The first set of inlets includes a first inlet 801 to supply hydraulic fluid to the first chamber 228 and a second inlet 802 to supply fluid to the third chamber 232. In some examples, the first inlet 801 and the second inlet 802 can be connected by a first passage 244. The passage 244 can be formed in the cylinder 152 or the passage 244 can be external to the cylinder 152. The hydraulic actuator further includes a second set of inlets to supply fluid to a second set of chambers. The second set of inlets includes a third inlet 808 to supply fluid to the second chamber 229 and a fourth inlet 809 to supply fluid to the fourth chamber 260. In some examples, the third inlet 808 and the fourth inlet 809 can be connected by a passage 264. The passage 264 can be formed in the cylinder 152 or the passage 244 can be external to the cylinder 152.

In operation, the hydraulic actuator 800 can move in the first direction (e.g., extension of the piston 156) when fluid is supplied to the first set of inlets and can move in the second direction (e.g., retraction of the piston 156) when fluid is supplied to the second set of inlets. When fluid is supplied from the pump 132 to the first set of inlets, the volume of the first chamber 228 and the third chamber 232 is increased and the piston 156 is caused to move in the first direction. The movement of the piston 156 in the first direction causes the volume of the second chamber 229 and the fourth chamber 260 to reduce. Correspondingly, fluid from the second chamber 229 and the fourth chamber 260 is expelled to the reservoir 148. Conversely, when fluid is supplied from the pump 132 to the second set of inlets, the volume of the second chamber 229 and the fourth chamber 260 is increased and the piston 156 is caused to move in the second direction. The movement of the piston 156 in the second direction causes the volume of the first chamber 228 and the third chamber 232 to reduce. Correspondingly, fluid from the first chamber 228 and the third chamber 232 is expelled to the reservoir 148. It is appreciated that a valve system can be provided to control the connections of the first set of inlets and the second set of inlets to each of the pump 132 and the reservoir 148.

The above examples of hydraulic actuators include cylinders with uniform diameter along their respective lengths. However, in some cases, a hydraulic cylinder can have different diameters (e.g., with respect to a body of a hydraulic tool and a head of the hydraulic tool) as can allow the force output to be modified and allow for varied tool sizing to meet particular use conditions.

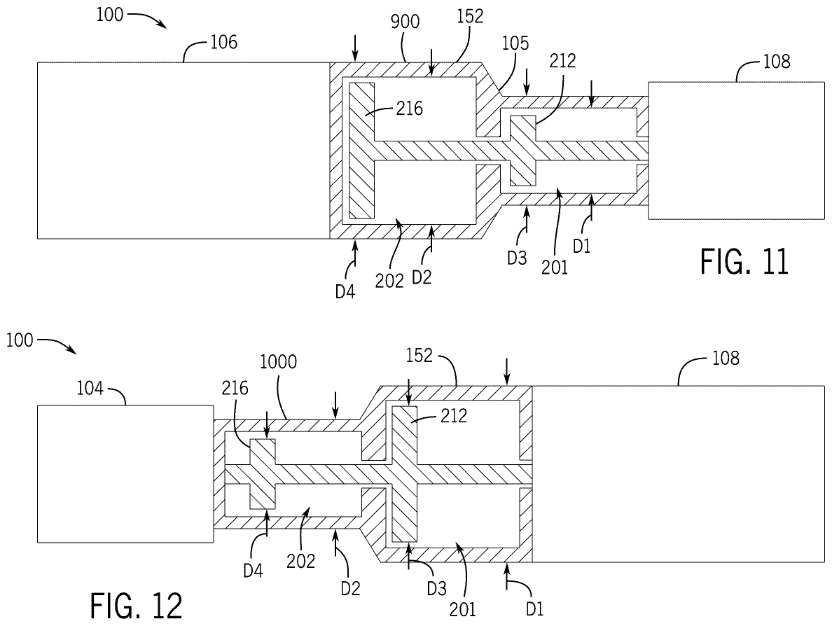

For example, FIG. 11 illustrates an example hydraulic actuator 900, which is another example of the hydraulic actuator 136 according to aspects of the disclosure for use with the hydraulic tool 100 of FIG. 1. To that end, features of the hydraulic actuator 900 described below include reference numbers that are generally similar to those used in FIGS. 1-10, and discussion applies to similar named and numbered items below, unless otherwise noted or required. Correspondingly, aspects described in relation to FIG. 11 can also be applied to the examples of FIGS. 1-10.

The hydraulic actuator 900 includes a hydraulic cylinder 152 that is within a cylinder housing 105. A pump housing 106 is attached to one end of the cylinder housing 105, and a head 108 is attached to the other end of the cylinder housing 105. The cylinder 152 has a first diameter D1 (e.g., internal diameter) corresponding to a first interior space 201 having a first piston head 212 and a second diameter D2 corresponding to a second interior space 202 having a second piston head 216. The first diameter D1 is smaller than the second diameter D2. Correspondingly, the first diameter D1 is provided proximate the head 108, while the second diameter D2 is provided at the opposite end of the cylinder housing 105 by the pump housing 106.

The cylinder housing 105 has a third diameter D3 (e.g., external diameter) and a fourth diameter D4. The third diameter D3 is provided proximate the tool head 108, while the fourth diameter D4 is provided at the opposite end of the cylinder housing 105 by the pump housing 106.

The smaller diameter D1 of the first piston head 212 and smaller diameter D3 of the cylinder housing 105 can allow the user to grip the hydraulic tool 100 more easily, while the larger diameter D2 of the second piston head 216 can allow for even greater force output.

In some cases, the third diameter D3 of the cylinder housing 105 can be a larger diameter of the fourth diameter D4 of the cylinder housing 105, while the first diameter D1 of the first piston head 212 is smaller than the second diameter D2 of the second piston head.

FIG. 12 illustrates an example hydraulic actuator 1000, which is another example of the hydraulic actuator 136 according to aspects of the disclosure for use with the hydraulic tool 100 of FIG. 1. To that end, features of the hydraulic actuator 1000 described below include reference numbers that are generally similar to those used in FIGS. 1-11, and discussion applies to similar named and numbered items below, unless otherwise noted or required. Correspondingly, aspects described in relation to FIG. 12 can also be applied to the examples of FIGS. 1-11.

As another example, the hydraulic actuator 1000 includes a first diameter D1 (e.g., internal diameter) that is larger than a second diameter D2. A cylinder housing 105 includes a third diameter D3 (e.g., external diameter) that is larger than a fourth diameter D4.

The larger diameter D1 of the first piston head 212 and larger diameter D3 of the cylinder housing 105 can allow for even greater force output, while the smaller diameter D2 of the second piston head 216 can allow the user to grip the hydraulic tool 100 more easily. In some cases, the fourth diameter D4 can be larger than the third diameter D3, while the first diameter D1 is larger than the second diameter D2.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

The above discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The above detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

It is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

Also as used herein, ordinal numbers are used for convenience of presentation only and are generally presented in an order that corresponds to the order in which particular features are introduced in the relevant discussion. Accordingly, for example, a “first” feature may not necessarily have any required structural or sequential relationship to a “second” feature, and so on. Further, similar features may be referred to in different portions of the discussion by different ordinal numbers. For example, a particular feature may be referred to in some discussion as a “first” feature, while a similar or substantially identical feature may be referred to in other discussion as a “third” feature, and so on.

The description of the different advantageous embodiments has been presented for purposes of illustration and description and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A hydraulic cylinder arrangement for a hydraulic tool, the hydraulic cylinder arrangement comprising:
a cylinder including a first wall and a second wall;
a piston assembly moveably disposed within the cylinder, the piston assembly including:
a piston rod,
a first piston head coupled to the piston rod to define a first chamber between the first piston head and the first wall, and
a second piston head coupled to the piston rod to define a second chamber between the second piston head and the second wall,
the first chamber and the second chamber being fluidly coupled to one another.

2. The hydraulic cylinder arrangement of claim 1, wherein the second piston head is secured to the piston rod with a first retainer.

3. The hydraulic cylinder arrangement of claim 2, wherein the second piston head is secured to the piston rod between a first seat and the first retainer.

4. The hydraulic cylinder arrangement of claim 1, wherein the first piston head is monolithically formed with the piston rod.

5. The hydraulic cylinder arrangement of claim 1, wherein the piston rod includes a first passage for fluid communication between the first chamber and the second chamber.

6. The hydraulic cylinder arrangement of claim 1, wherein the second chamber is in fluid communication with a pump passage.

7. The hydraulic cylinder arrangement of claim 1, wherein a third chamber is defined by the first piston head and a third wall of the hydraulic cylinder, and wherein a fourth chamber is defined by the first wall and the second piston head.

8. The hydraulic cylinder arrangement of claim 7, wherein the piston rod includes a second passage for fluid communication between the third chamber and the fourth chamber.

9. The hydraulic cylinder arrangement of claim 7, wherein the third chamber is in fluid communication with a tank passage.

10. The hydraulic cylinder arrangement of claim 7, wherein a first spring is disposed in the third chamber, and a second spring is disposed in the fourth chamber.

11. The hydraulic cylinder arrangement of claim 1, wherein the first wall is secured to the cylinder between a second retainer and a second seat, and wherein the second wall is an end wall of the cylinder.

12. The hydraulic cylinder arrangement of claim 11, wherein the end wall is an end cap that is coupled to the cylinder.

13. A hydraulic actuator, comprising:
a first cylinder defining a first interior space and including a first open end and a first closed end;
a second cylinder defining a second interior space and including a second open end and a second closed end, the second closed end received in the first open end of the first cylinder;
a piston assembly moveably disposed within the first interior space and the second interior space, the piston assembly including:
a first piston having a first piston head positioned within the first interior space and a first piston rod extending through the second closed end in to the second interior space, the first piston head defining a first chamber at the first closed end and a second chamber at the first open end within the first interior space, and
a second piston having a second piston head positioned within the second interior space and a second piston rod, the second piston head coupled to the first piston rod so that the second piston moves with the first piston, and the second piston head defining a third chamber at the second closed end and a fourth chamber at the second open end within the second interior space, the third chamber fluidly coupled to the first chamber by a first passage defined in the first piston.

14. The hydraulic actuator of claim 1, wherein the first piston defines a fifth chamber that receives a conduit tube that extends from the first closed end.

15. The hydraulic actuator of claim 14, wherein hydraulic fluid is supplied to the fifth chamber during a first stage of operation to move the piston assembly at a first speed, and
where hydraulic fluid is supplied to the first chamber and the second chamber during a second stage of operation to move the piston assembly at a second speed that is slower than the first speed.

16. The hydraulic actuator of claim 13, wherein the second piston includes a relief valve.

17. The hydraulic actuator of claim 16, wherein the relief valve is in a second passage defined in the second piston rod.

18. A hydraulic actuator, comprising:
a first cylinder defining a first interior space and including a first closed end and a first open end;
a second cylinder defining a second interior space and including a second closed end and a second open end that is coupled to the first closed end;
a conduit tube extending from the second closed end of the first cylinder
a first piston having a first piston head positioned within the first interior space and a second piston rod, the first piston head defining a first chamber at the first closed end and a second chamber at the first open end within the first interior space; and
a second piston having a first piston having a second piston head positioned within the second interior space and a second piston rod extending through the first closed end into the first interior space, the second piston defining a second passage that receives the conduit tube to fluidly couple the first chamber to the conduit tube and to fluidly decouple the first chamber from the third chamber.

19. The hydraulic actuator of claim 18, wherein hydraulic fluid is supplied to the first chamber during a first stage of operation to move the piston assembly at a first speed, and
where hydraulic fluid is supplied to the first chamber and the second chamber during a second stage of operation to move the piston assembly at a second speed that is slower than the first speed.

20. The hydraulic actuator of claim 18, wherein the first piston defines a first passage that is selectively fluidly coupled to the second passage by a relief valve.
